(19) United States
(12) Patent Application Publication
(10) Pub. No.: US 2026/0340897 A1
(43) Pub. Date: Oct. 29, 2026

(54) TRAINING-FREE TEXT LEGIBILITY ENHANCEMENT IN DIFFUSION-BASED IMAGE GENERATION THROUGH OCR GUIDANCE

(71) Applicant: ADOBE INC., SAN JOSE, CA (US)

(72) Inventors: Nipun Jindal, Delhi (IN); Marian Lupascu, Bucharest District 3 (RO)

(21) Appl. No.: 19/375,918

(22) Filed: Oct. 31, 2025

Related U.S. Application Data
(60) Provisional application No. 63/793,086, filed on Apr. 23, 2025.

(51) Int. Cl. G06T 11/60; G06T 5/70; G06T 7/00

(52) U.S. Cl. CPC G06T 11/60; G06T 5/70; G06T 7/0002; G06T 2207/20084; G06T 2207/30168

(57) ABSTRACT

A method, apparatus, non-transitory computer readable medium, and system for image processing include obtaining an input prompt indicating a target visual text, generating an intermediate image based on the input prompt, computing a character recognition loss based on the target visual text and the intermediate image, and generating a synthetic image based on the character recognition loss, where the synthetic image depicts the target visual text.

### CROSS-REFERENCE TO RELATED APPLICATION

This application claims priority under 35 U.S.C. § 119 to U.S. Provisional Application No. 63/793,086, filed on Apr. 23, 2025, in the United States Patent and Trademark Office, the disclosure of which is incorporated by reference herein in its entirety.

### BACKGROUND

The following relates generally to image processing, and more specifically to image generation using a machine learning model. Image processing refers to the use of a computer to edit or generate an image using an algorithm or a processing network. In some cases, image processing software can be used for various image processing tasks, such as image restoration, image detection, image editing, image compositing, and image generation.

In some cases, image generation involves conditioning a generative machine learning model based on an input text prompt to generate output images that include one or more visual features described in the input text prompt. For example, the model may be conditioned to generate an image that reflects the described scene and includes embedded text, such as titles, labels, or quotes. However, while generative models are capable of capturing high-level semantic context, these models often struggle to generate legible and structurally consistent text within the generated image.

### SUMMARY

Embodiments of the present disclosure provide a method and system for text-to-image generation, and more specifically for text enhancement in image generation. In one aspect, the system generates a synthetic image depicting a target visual text based on an input text prompt describing the target visual text. In one aspect, the system includes an optical character recognition (OCR) model configured to perform character recognition on the input text prompt to generate a character recognition loss. For example, the character recognition loss represents a degree of legibility of the target visual text in an intermediate image. In some aspects, the system generates a character recognition gradient (in latent space) based on the character recognition loss (e.g., from the pixel space). In some embodiments, the character recognition loss is generated based on an intermediate image generated in the pixel space, but in other embodiments the character recognition loss may be generated based on character recognition performed in the latent space.

During the image generation process (e.g., a reverse diffusion process or denoising process), the system includes an image generation model configured to generate an image feature based on a text embedding of the input text prompt. In an embodiment, the character recognition loss is used to guide the image generation process, so that the image generation model can generate a synthetic image having content from the input text prompt and depicting a legible target visual text described by the text prompt.

A method, apparatus, non-transitory computer readable medium, and system for image processing include obtaining an input prompt indicating a target visual text, generating an intermediate image based on the input prompt, computing a character recognition loss based on the target visual text and the intermediate image, and generating a synthetic image based on the character recognition loss, where the synthetic image depicts the target visual text.

A method, apparatus, non-transitory computer readable medium, and system for image processing include obtaining an input prompt indicating a target visual text, generating an intermediate image based on the input prompt, performing character recognition on the intermediate image to obtain a predicted visual text, and generating a synthetic image based on the target visual text and the predicted visual text, where the synthetic image depicts the target visual text.

An apparatus and system for image processing include a memory component, and a processing device coupled to the memory component, the processing device configured to perform operations comprising: obtaining an input prompt indicating a target visual text, generating an intermediate image based on the input prompt, computing a character recognition loss based on the target visual text and the intermediate image, and generating a synthetic image based on the character recognition loss, where the synthetic image depicts the target visual text.

### BRIEF DESCRIPTION OF THE DRAWINGS

FIG. 1 shows an example of an image processing system according to aspects of the present disclosure.

FIG. 2 shows an example of a method for text conditioning image generation according to aspects of the present disclosure.

FIG. 3 shows an example of a method for image generation using character recognition loss according to aspects of the present disclosure.

FIG. 4 shows an example of a method for image generation by performing optical character recognition according to aspects of the present disclosure.

FIG. 5 shows an example of text-to-image generation according to aspects of the present disclosure.

FIG. 6 shows an example of a machine learning model according to aspects of the present disclosure.

FIG. 7 shows an example of an image generation model according to aspects of the present disclosure.

FIG. 8 shows an example of a U-Net architecture according to aspects of the present disclosure.

FIG. 9 shows an example of a diffusion transformer model according to aspects of the present disclosure.

FIG. 10 shows an example of a diffusion process according to aspects of the present disclosure.

FIG. 11 shows an example of a pseudocode for OCR-guided diffusion according to aspects of the present disclosure.

FIG. 12 shows an example of a flow diagram depicting an algorithm as a step-by-step procedure in an example implementation of operations performable for training a machine learning model according to aspects of the present disclosure.

FIG. 13 shows an example of a method for training a diffusion model according to aspects of the present disclosure.

FIG. 14 shows an example of an image processing apparatus according to aspects of the present disclosure.

FIG. 15 shows an example of a computing device according to aspects of the present disclosure.

### DETAILED DESCRIPTION

The following relates to text-to-image generation using a machine learning model. Embodiments of the present disclosure relate to an image generation system that accurately generates a synthetic image depicting a display text described by an input text prompt. The system generates the synthetic image that enhances the readability of text generated within synthetic images without retraining the image generation model or altering the architecture of the image generation model. This is achieved by integrating a character recognition loss or feedback into the noise prediction process (or the diffusion process) of the image generation model, which refines the generation of text elements and preserves the image quality and fidelity.

According to some embodiments, the system includes an optical character recognition (OCR) model configured to generate OCR guidance (e.g., the character recognition loss or the character recognition gradient) during the inference phase of the image generation process. The character recognition loss provides a level of accuracy representing the generated text at intermediate stages of the diffusion process. During an intermediate image processing timestep, the OCR model computes gradients (e.g., a latent vector) from the OCR loss and applies normalized guidance to adjust latent representations generated by the image generation model. This guidance enhances the semantic accuracy and structural clarity of rendered text, while preserving the image quality and fidelity.

In some embodiments, during the guided image generation process, the model applies OCR-based updates iteratively or in a single pass. The guidance is applied selectively within a predetermined timestep range to maximize impact. By using semantic feedback from the OCR model, the system enhances the practical utility of diffusion-based image generation models in applications that generate images including display text.

Conventional image generation systems may include diffusion-based generative models trained to synthesize images from input text prompts. These systems operate through a denoising process that converts random noise into clear images that align with the input prompt. During inference, these systems apply guidance mechanisms, such as classifier-free guidance (CFG), to improve alignment between generated images and text conditions. Although CFG enhances visual fidelity and prompt relevance, CFG lacks the capability to explicitly control or improve the legibility of embedded text within the generated images.

Some conventional systems attempt to improve text fidelity by modifying the model architecture or retraining on specialized datasets with annotated text regions. These systems may inject structural priors or using segmentation masks to localize text regions, which are then refined during training. In some cases, this technique may enhance the structural placement of text. However, these systems may be computationally expensive and cannot be generalized across different domains. Moreover, architectural changes can introduce trade-offs that negatively affect overall image quality or model flexibility.

Some conventional systems use external control signals (e.g., edge maps or pose estimations) to influence the layout and appearance of the generated image. These systems can enforce alignment with desired structures, including text shapes or placements. However, these systems do not provide semantic-level feedback and are limited to visual resemblance, which does not ensure that the generated text is actually readable or semantically accurate.

Some conventional systems modify the conditioning embeddings used in the generation process to implicitly guide output content. These systems may use lightweight enhancer networks to amplify prompt alignment and improve global visual coherence. However, these systems do not explicitly address text rendering and thus fail to generate consistently legible or correct text within the image.

Gradient-free classifier guidance (GFCG) and other classifier-guided sampling systems provide a mechanism for improving class-specific image accuracy by using pretrained classifiers. These systems use external classifiers to steer the sampling process toward images with higher predicted confidence for a given class. However, these systems are trained for class-based guidance and provide no functionality to evaluate or optimize text readability. Accordingly, these systems unsuitable for applications requiring accurate text generation.

Accordingly, embodiments of the present disclosure improve on conventional image generation systems by accurately generating legible text within a synthetic image using OCR guidance. This is achieved by integrating an OCR model into the inference process of an image generation model to generate OCR-based guidance signals. In one aspect, the system computes gradient information from an OCR loss that represents the accuracy of the generated text (in an intermediate image) relative to a target text described in the input text prompt. By selectively applying the OCR gradients during the denoising steps, the system refines the latent representations that enhances the semantic and visual quality of the rendered text. In some cases, by applying the OCR gradients in a predetermined denoising timestep range, the system can efficiently apply the OCR guidance. Accordingly, the image generation model can generate images that include accurate content and legible text aligned with the input text prompt without retraining the image generation model.

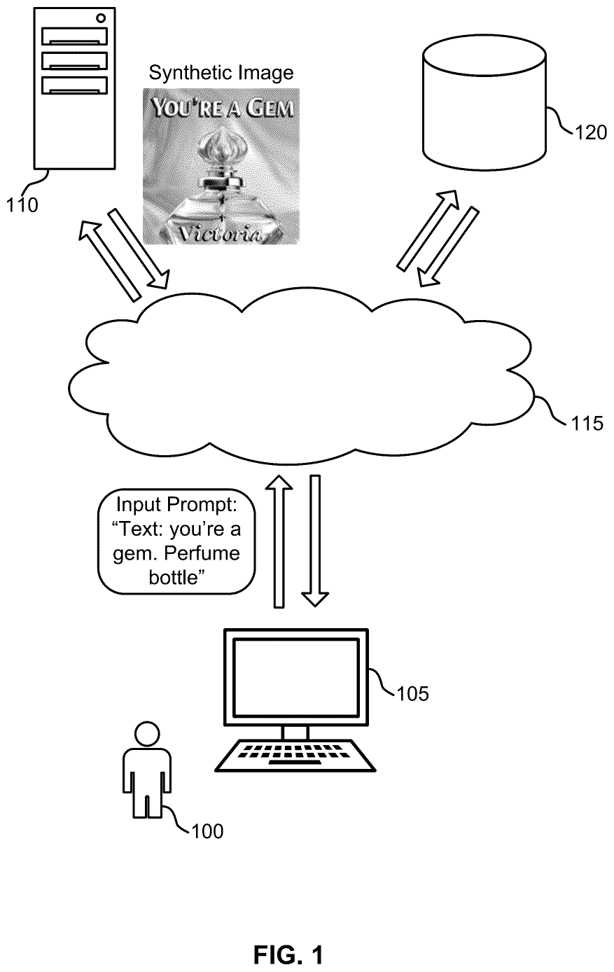

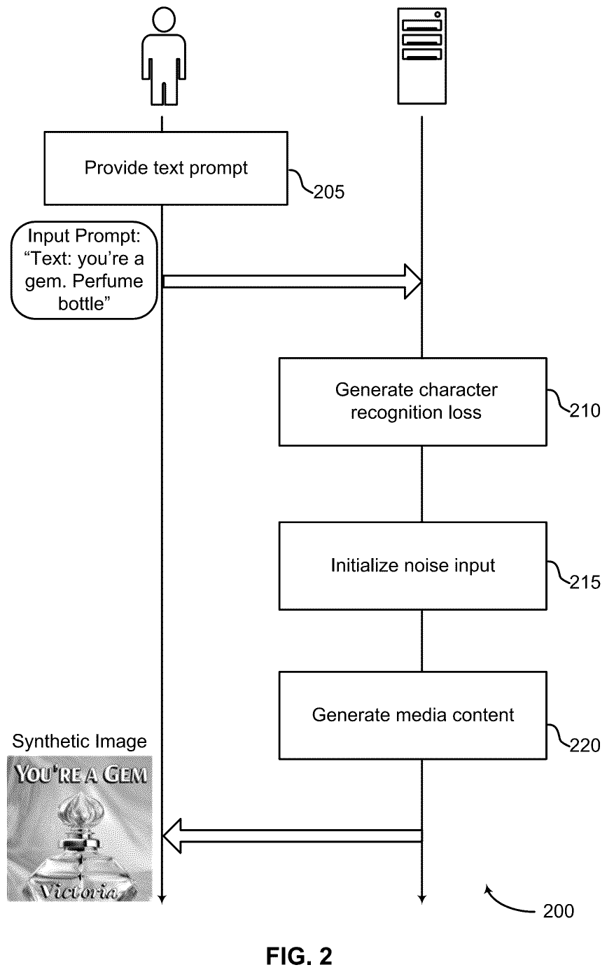

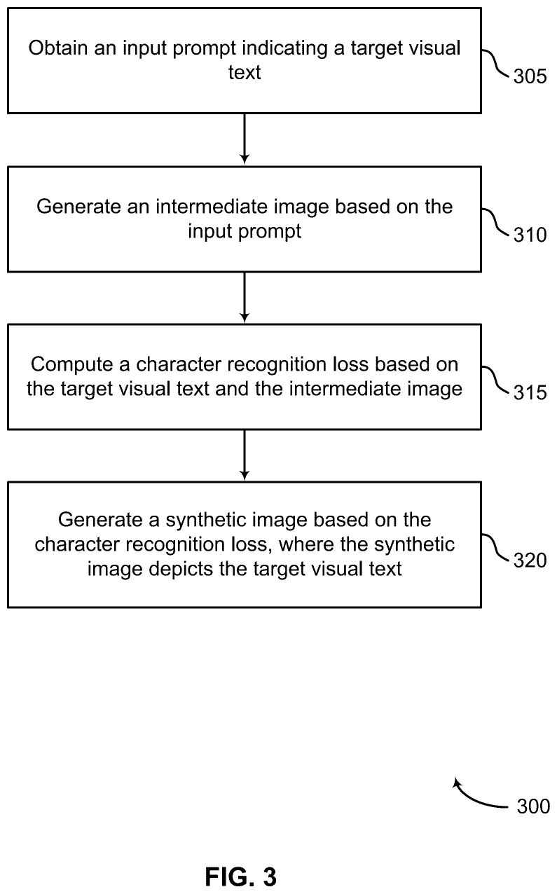

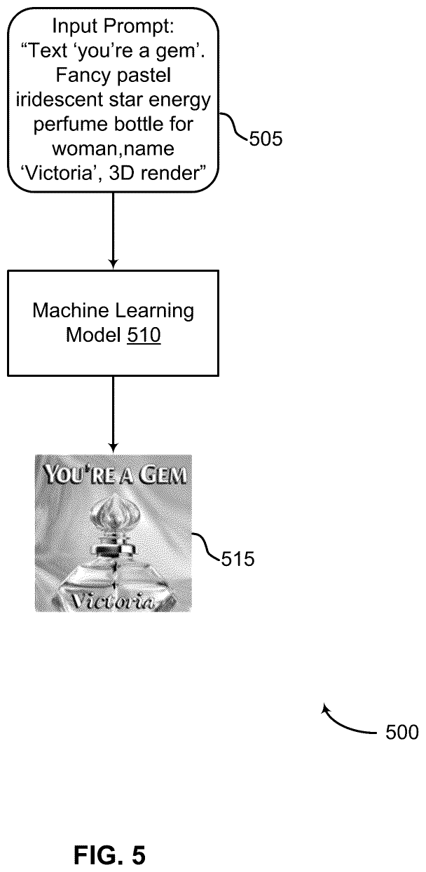

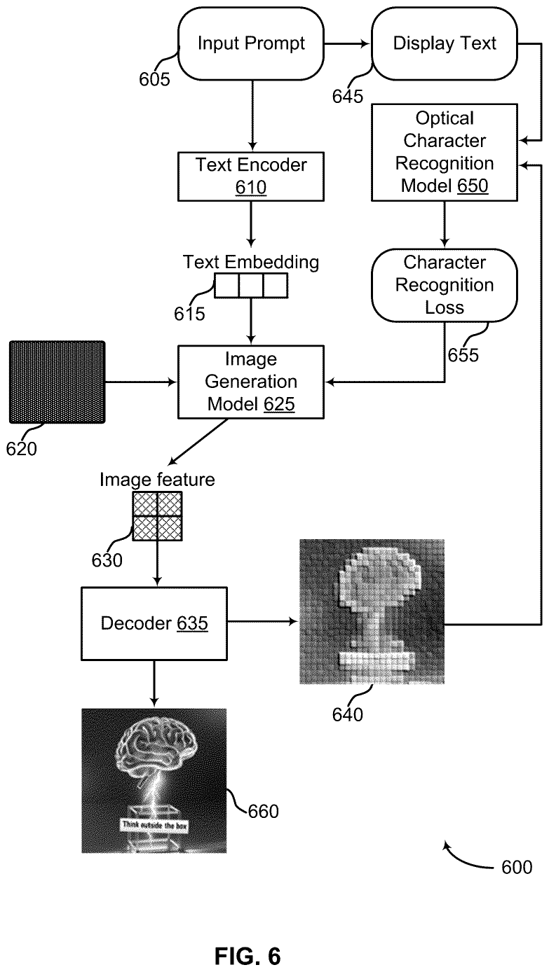

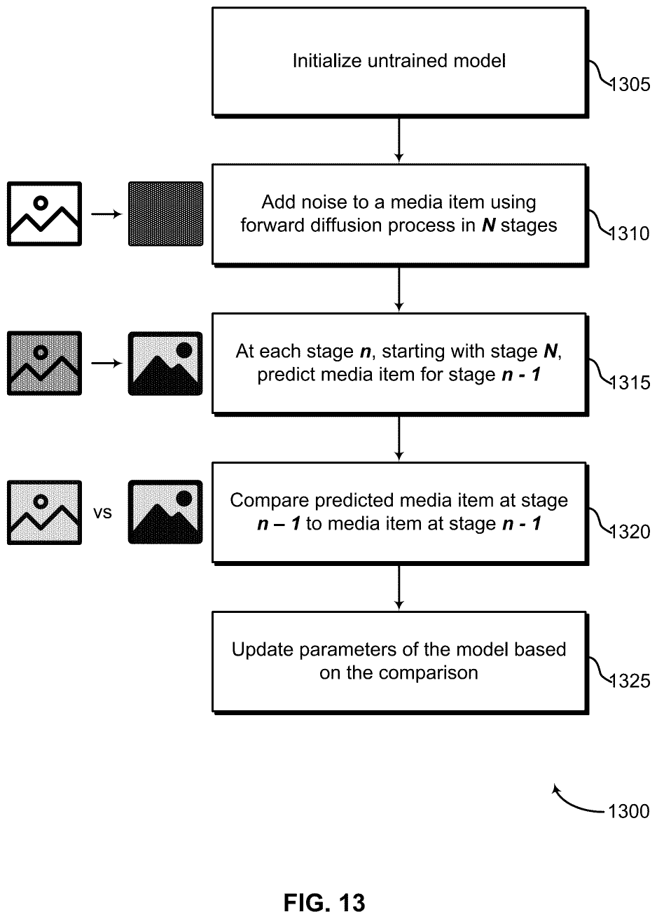

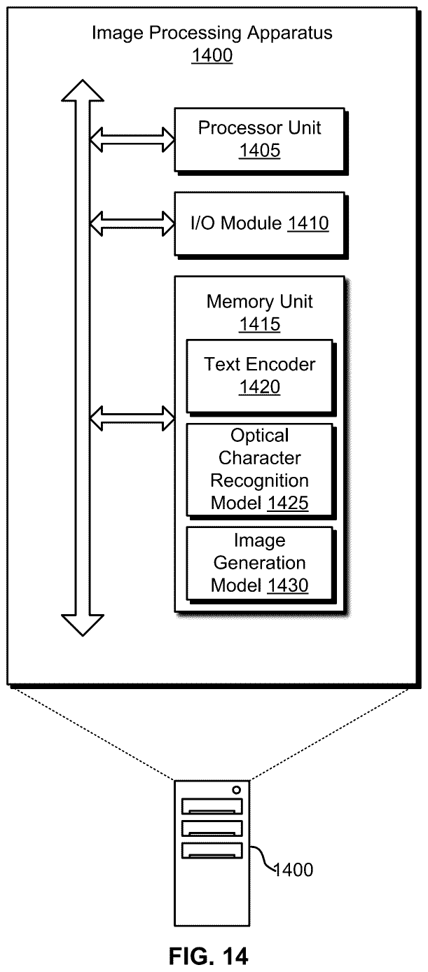

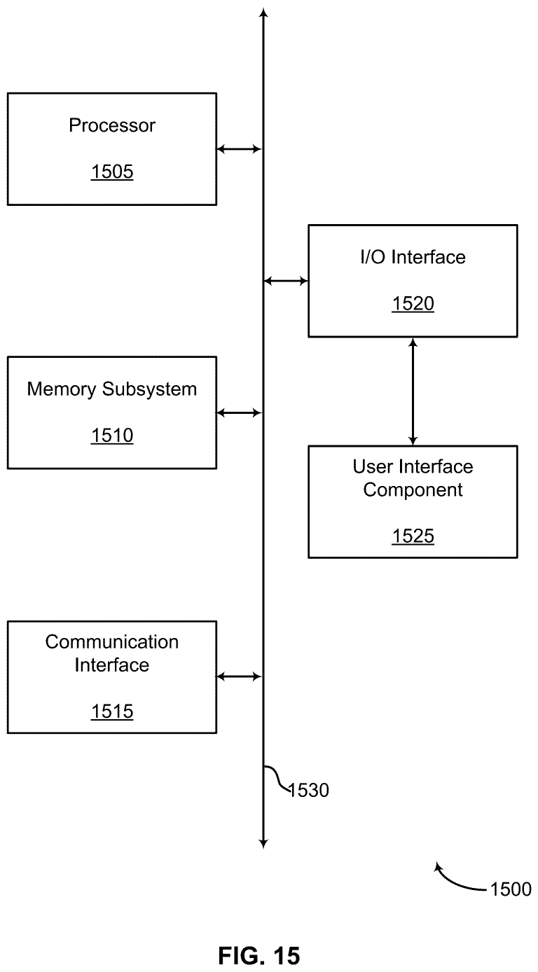

An example system of the present disclosure in image processing is provided with reference to FIGS. 1 and 15. An example application of the present disclosure in image processing is provided with reference to FIGS. 2 and 5. Details regarding the architecture of an image processing apparatus are provided with reference to FIGS. 6-9 and 14. An example of a process for image processing is provided with reference to FIGS. 3-4 and 10-11. A description of an example training process is provided with reference to FIG. 13-14.

Accordingly, embodiments of the present disclosure provide a system and method that improves on conventional image generation systems by enhancing the legibility of text generated within a synthetic image. By integrating OCR-based guidance directly into the diffusion sampling process, the system can control the image generation toward semantically accurate and visually coherent text. In some aspects, by applying guidance during a predetermined range of diffusion timesteps, the system reduces computational cost while maintaining image quality. The guidance mechanism is plug-and-play and can be augmented to a pre-trained diffusion model. In some aspects, the system provides a normalized gradient application technique to ensure stability and to prevent distortion of non-text elements in the synthetic image.

As used herein, input prompt, text prompt, or input text prompt refers to an input such as a description (or a natural language description) provided to a machine learning model to guide the content and composition of a synthetic image. The input prompt may include natural language instructions, keywords, or phrases that describe target visual elements, themes, or textual content to appear in the synthetic image. In some cases an input prompt can include non-text modalities such as images or layout information.

Target visual text, visual text, or intermediate visual text refers to the specific text string to be generated legibly within the synthetic image. This may include phrases, words, or characters that are semantically meaningful and visually coherent when generated.

A character recognition loss is a loss function used to quantify the differences between text recognized, e.g., by an OCR model, from a generated image and the target visual text. This loss represents how accurately the text content of the synthetic image aligns with the target visual text. For example, a lower character recognition loss indicates better legibility and semantic alignment of the rendered text. In some cases, the character recognition loss may be computed in a pixel space.

A synthetic image refers to an image generated by a machine learning model, such as a diffusion model, in response to an input prompt. The synthetic image may include visual elements such as objects, backgrounds, and textual content that are synthesized. The synthetic image is generated through iterative denoising a noise input. In some cases, the pixels of the synthetic image are generated by the machine learning model.

An intermediate image refers to a partially denoised image generated at a particular timestep during the reverse diffusion process. Intermediate image represents transitional stages in the generation of the final synthetic image and is used to guide the progression of visual content, including text rendering. Intermediate images may include noisy inputs, pixels, image features, or a combination thereof.

An image feature refers to an abstract representation of visual characteristics extracted from an image using convolutional or transformer-based encoders. These features include spatial, textural, and semantic information and are used by the image generation model to produce modified images. In some cases, image features may be represented in a latent space or embedding space.

A latent space refers to a continuous, multi-dimensional space in which embeddings are represented. The latent space encodes semantic or visual features in a compact form, allowing for efficient manipulation and processing. In image generation, both text and image embeddings are positioned in the latent space (or multimodal space) to guide the output generation.

Character recognition refers to the process of detecting and interpreting textual content within an image using an OCR model. This includes the identification of individual characters, words, and the semantic structure of the text. The output of character recognition may be used to evaluate the correctness and legibility of text within synthetic images.

A character recognition gradient refers to the derivative of the character recognition loss with respect to the latent image representation. This gradient indicates how changes in the image affect OCR performance and is used to guide the image generation process toward improved text legibility. The gradient is applied during diffusion to refine the visual text features in the image. In some cases, the character recognition gradient is generated in the latent space.

A diffusion timestep or diffusion timestep range refers to the specified set of timesteps within the reverse diffusion process during which character recognition guidance is applied. By limiting guidance to a predetermined range (e.g., during the mid-phase of sampling), the system maximizes the influence of OCR gradients while preserving overall image fidelity.

Classifier-free guidance (CFG) is a method used in diffusion models to improve alignment with conditioning information (e.g., input prompt) by combining conditional and unconditional noise predictions. The method enhances control over the generation process without the need for an external classifier. CFG operates during inference and enables tuning the strength of conditioning through a guidance scale parameter.

A character recognition strength parameter refers to a scalar value that determines the magnitude of influence by the character recognition gradients during the image generation process. This parameter controls how strongly the OCR guidance alters the latent representation at each timestep. For example, a high strength parameter leads to a high focus on text legibility, while a low value preserves more of the original generative distribution.

### OCR-Guided Image Generation

In FIGS. 1-5 and 10-11, a method, apparatus, non-transitory computer readable medium, and system for image processing include obtaining an input prompt indicating a target visual text, generating an intermediate image based on the input prompt, computing a character recognition loss based on the target visual text and the intermediate image, and generating a synthetic image based on the character recognition loss, where the synthetic image depicts the target visual text.

Some examples of the method, apparatus, non-transitory computer readable medium, and system further include performing character recognition on the intermediate image to obtain a predicted visual text. Some examples further include comparing the predicted visual text to the target visual text.

Some examples of the method, apparatus, non-transitory computer readable medium, and system further include obtaining a noise input. Some examples further include denoising the noise input based on the character recognition loss. Some examples of the method, apparatus, non-transitory computer readable medium, and system further include computing a character recognition gradient based on the character recognition loss, where the noise input is denoised based on the character recognition gradient.

Some examples of the method, apparatus, non-transitory computer readable medium, and system further include identifying a diffusion timestep range, where the character recognition loss is applied within the diffusion timestep range. Some examples of the method, apparatus, non-transitory computer readable medium, and system further include computing classifier free guidance based on the character recognition loss.

Some examples of the method, apparatus, non-transitory computer readable medium, and system further include obtaining a character recognition strength parameter indicating a target strength of the character recognition loss, where the character recognition loss is applied based on the character recognition strength parameter. Some examples of the method, apparatus, non-transitory computer readable medium, and system further include normalizing the character recognition loss to obtain a normalized character recognition loss, where the synthetic image is generated based on the normalized character recognition loss.

A method, apparatus, non-transitory computer readable medium, and system for image processing include obtaining an input prompt indicating a target visual text, generating an intermediate image based on the input prompt, performing character recognition on the intermediate image to obtain a predicted visual text, and generating a synthetic image based on the target visual text and the predicted visual text, where the synthetic image depicts the target visual text.

Some examples of the method, apparatus, non-transitory computer readable medium, and system further include computing a character recognition loss based on the character recognition, where the synthetic image is generated based on the character recognition loss. Some examples of the method, apparatus, non-transitory computer readable medium, and system further include obtaining a noise input. Some examples further include denoising the noise input based on the character recognition loss.

Some examples of the method, apparatus, non-transitory computer readable medium, and system further include computing a character recognition gradient based on the character recognition loss, where the noise input is denoised based on the character recognition gradient.

Some examples of the method, apparatus, non-transitory computer readable medium, and system further include identifying a diffusion timestep range, where the character recognition loss is applied within the diffusion timestep range. Some examples of the method, apparatus, non-transitory computer readable medium, and system further include computing classifier free guidance based on the character recognition loss.

Some examples of the method, apparatus, non-transitory computer readable medium, and system further include obtaining a character recognition strength parameter indicating a target strength of the character recognition loss, where the character recognition loss is applied based on the character recognition strength parameter.

Some examples of the method, apparatus, non-transitory computer readable medium, and system further include normalizing the character recognition loss to obtain a normalized character recognition loss, where the synthetic image is generated based on the normalized character recognition loss.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 13.

Referring to FIG. 1, a user 100 provides an input prompt to an image processing apparatus 110 via a user device 105 and cloud 115. The input prompt includes descriptive text describing semantic content and target visual text to be generated in a synthetic image. For example, the prompt may state: “Text: you're a gem. Perfume bottle.” The image processing apparatus 110 receives the input prompt and generates a text embedding based on the input prompt. The text embedding is used to guide the image generation process to generate the synthetic image. The synthetic image depicts visual elements and the target visual text described by the input prompt.

In some aspects, the image processing apparatus 110 includes a text encoder configured to encode the input prompt into a text embedding, where the text embedding captures the compositional context and the intended textual content. The text embedding is used to guide an image generation process (e.g., a diffusion process) that operates in latent space to synthesize image features across a predetermined diffusion timestep range. The image processing apparatus 110 includes an OCR model configured to generate character recognition loss that evaluates intermediate image outputs and provides character recognition gradients during sampling to enhance the legibility of the target visual text (e.g., “YOU'RE A GEM” and “Victoria”) in the synthetic image. The machine learning model may generate the synthetic image based on the text embedding and the character recognition gradient. The synthetic image is transmitted via cloud 115 to the user device 105, where the synthetic image is displayed to the user 100 with enhanced text legibility and visual coherence.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

According to some aspects, image processing apparatus 110 includes a computer implemented network comprising a machine learning model, a text encoder, an image encoder, and an image generation model. Image processing apparatus 110 further includes a processor unit, a memory unit, an I/O module, and a training component. In some embodiments, image processing apparatus 110 further includes a communication interface, user interface components, and a bus as described with reference to FIG. 15. Additionally or alternatively, image processing apparatus 110 communicates with user device 105 and database 120 via cloud 115. Image processing apparatus 110 is an example of, or includes aspects of, the corresponding element described with reference to FIG. 14. Further details regarding the operation of image processing apparatus 110 are described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data (or training set), input image, text prompts, etc. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for text conditioning image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 205, the user provides a text prompt to the system. In some cases, the operations of this step refer to, or may be performed by, a user as described with reference to FIG. 1. The input prompt includes a textual description instructing the generation of a target visual content and target visual text, such as “Text: you're a gem. Perfume bottle.” The text prompt is transmitted to an image processing apparatus for further processing.

At operation 210, the system generates character recognition loss. In some cases, the operations of this step refer to, or may be performed by, an image processing apparatus as described with reference to FIGS. 1 and 14. In some cases, the operations of this step refer to, or may be performed by, an optical character recognition model as described with reference to FIGS. 6 and 14. In some cases, a text encoder encodes the input prompt into a text embedding. The text embedding captures semantic and textual information from the text prompt and is used to guide the image generation process. In some cases, the guidance embedding includes a character recognition loss. For example, the optical character recognition model generates a character recognition loss based on the target visual text and an intermediate image generated by the image generation model. In some cases, the text embedding and the character recognition loss may be combined to obtain the guidance embedding. The guidance embedding may be applied via cross-attention mechanisms at various layers of the image generation model to condition the sampling process toward the described scene and target visual text.

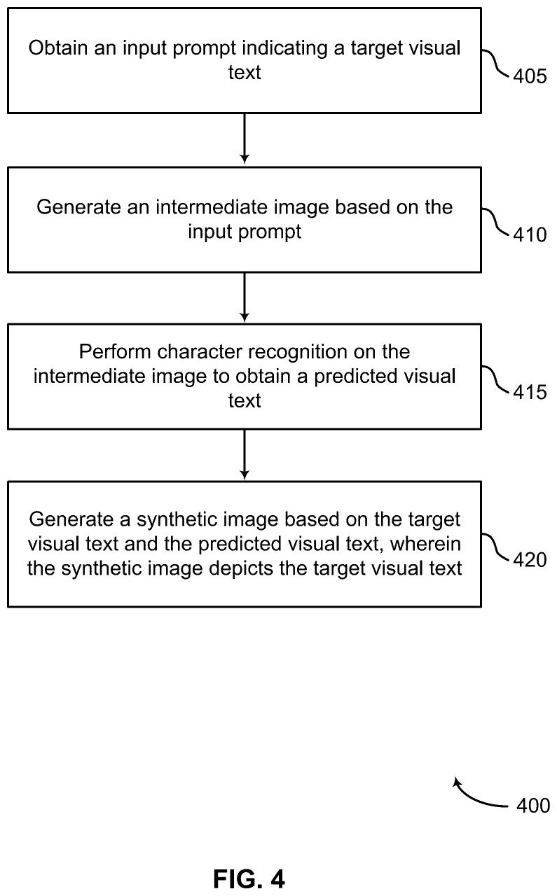

At operation 215, the system initializes noise input. In some cases, the operations of this step refer to, or may be performed by, an image processing apparatus as described with reference to FIGS. 1 and 4. In some cases, the operations of this step refer to, or may be performed by, an image generation model as described with reference to FIGS. 6 and 14. In some cases, the noise input is initialized by including random noise. The noise input may be in a latent space. By initializing the image generation model with random noise, different variations of a synthetic image can be generated. In some cases, a conditional embedding such as a text embedding may be combined with a noisy feature using a cross-attention block within the image generation model to guide the image generation process. In some cases, a conditional embedding or feature such as character recognition loss or character recognition gradient may be combined with the noisy feature using a cross-attention block within the image generation model to guide the image generation process.

At operation 220, the system generates media content. In some cases, the operations of this step refer to, or may be performed by, an image processing apparatus as described with reference to FIGS. 1 and 14. In some cases, the operations of this step refer to, or may be performed by, an image generation model as described with reference to FIGS. 6 and 14. For example, the system generates the media content, such as a synthetic image, by progressively refining the noisy input. During the denoising process, character recognition gradients computed from the OCR model may be applied at predetermined diffusion timestep ranges to enhance the legibility of target text in the image (e.g., “YOU'RE A GEM” and “Victoria”). The system generates a synthetic image depicting visual features and include readable text elements that align with the input text prompt. The synthetic image is returned to the user for viewing or downstream applications.

FIG. 3 shows an example of a method 300 for image generation using character recognition loss according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 305, the system obtains an input prompt indicating a target visual text. In some cases, the operations of this step refer to, or may be performed by, an image generation model as described with reference to FIGS. 6 and 14. In some cases, the system obtains an input prompt that includes or describes a target visual text. The input prompt may be provided by a user and includes semantic and textual content that the synthetic image is intended to depict.

Input prompt, text prompt, or input text prompt refers to a textual description (or a natural language description) provided to a machine learning model to guide the content and composition of a synthetic image. The input prompt may include natural language instructions, keywords, or phrases that describe target visual elements, themes, or textual content to appear in the synthetic image.

Target visual text, visual text, or intermediate visual text refers to the specific text string to be generated legibly within the synthetic image. This may include phrases, words, or characters that are semantically meaningful and visually coherent when generated.

At operation 310, the system generates an intermediate image based on the input prompt. In some cases, the operations of this step refer to, or may be performed by, an image generation model as described with reference to FIGS. 6 and 14. For example, the input prompt is provided to a text encoder to generate a text embedding. Then, an image generation model generates latent image features based on the text embedding guidance. For example, the image generation model is initialized with a random noise, and the text embedding is used to guide the reverse diffusion process. In some cases, a decoder is used to decode the intermediate image feature to generate an intermediate image depicting content (e.g., the target visual text or a predicted visual text) described by the text prompt (or the input prompt).

At operation 315, the system a character recognition loss based on the target visual text and the intermediate image. In some cases, the operations of this step refer to, or may be performed by, an optical character recognition model as described with reference to FIGS. 6 and 14. In some cases, the system computes a character recognition loss based on the target visual text. In some aspects, the system (or an image generation model) generates an intermediate image (e.g., a noisy image), and the system generates a character recognition loss by evaluating how accurately the generated text within the intermediate image matches the target visual text. The OCR loss quantifies the mismatch between the recognized text within the intermediate image and the target visual text. In some cases, the character recognition loss is computed in a pixel space.

Character recognition loss is a loss function used to quantify the differences between text recognized by an OCR model from a generated image and the target visual text. This loss represents how accurately the text content of the synthetic image aligns with the target visual text. For example, a lower character recognition loss indicates better legibility and semantic alignment of the rendered text. In some cases, the character recognition loss may be computed in a pixel space.

Intermediate image refers to a partially denoised image generated at a particular timestep during the reverse diffusion process. Intermediate image represents transitional stages in the generation of the final synthetic image and is used to guide the progression of visual content, including text rendering. Intermediate images may include noisy inputs, pixels, image features, or a combination thereof.

An image feature refers to an abstract representation of visual characteristics extracted from an image using convolutional or transformer-based encoders. These features include spatial, textural, and semantic information and are used by the image generation model to produce modified images. In some cases, image features may be represented in a latent space or embedding space.

Latent space refers to a continuous, multi-dimensional space in which embeddings are represented. The latent space encodes semantic or visual features in a compact form, allowing for efficient manipulation and processing. In image generation, both text and image embeddings are positioned in the latent space (or multimodal space) to guide the output generation.

At operation 320, the system generates a synthetic image based on the character recognition loss, where the synthetic image depicts the target visual text. In some cases, the operations of this step refer to, or may be performed by, an image generation model as described with reference to FIGS. 6 and 14. In some cases, the system generates a synthetic image using a diffusion-based image generation model, where the generation process is guided by the input prompt and the computed character recognition loss. During reverse diffusion, the system applies character recognition gradient obtained from the OCR loss to selectively modify latent image features at predetermined diffusion timesteps. by doing so, the system enhances the legibility and semantic correctness of the rendered text, allowing the synthetic image to more accurately and clearly depict the target visual text.

Character recognition gradient refers to the derivative of the character recognition loss with respect to the latent image representation. This gradient indicates how changes in the image affect OCR performance and is used to guide the image generation process toward improved text legibility. The gradient is applied during diffusion to refine the visual text features in the image. In some cases, the character recognition gradient is generated in the latent space.

Diffusion timestep or diffusion timestep range refers to the specified set of timesteps within the reverse diffusion process during which character recognition guidance is applied. By limiting guidance to a predetermined range (e.g., during the mid-phase of sampling), the system maximizes the influence of OCR gradients while preserving overall image fidelity.

Synthetic image refers to an image generated by a machine learning model, such as a diffusion model, in response to an input prompt. The synthetic image may include visual elements such as objects, backgrounds, and textual content that are synthesized. The synthetic image is generated through iterative denoising a noise input. In some cases, the pixels of the synthetic image are generated by the machine learning model.

FIG. 4 shows an example of a method for image generation by performing optical character recognition according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 405, the system obtains an input prompt indicating a target visual text. In some cases, the operations of this step refer to, or may be performed by, an image generation model as described with reference to FIGS. 6 and 14. The input prompt may be provided by a user and includes both semantic descriptors and a target visual text to be depicted in the final synthetic image. For example, the prompt may state, “Text ‘you're a gem.’ Fancy pastel iridescent star energy perfume bottle for woman, name ‘Victoria’, 3D render.”

At operation 410, the system generates an intermediate image based on the input prompt. In some cases, the operations of this step refer to, or may be performed by, an image generation model as described with reference to FIGS. 6 and 14. For example, a text encoder generates a text embedding from the input prompt, and an image generation model synthesizes latent image features based on the text embedding. A decoder may then be used to decode the latent features into an intermediate image that at least partially depicts the semantic content and target visual text described by the text prompt.

At operation 415, the system performs character recognition on the intermediate image to obtain a predicted visual text. In some cases, the operations of this step refer to, or may be performed by, an optical character recognition (OCR) model as described with reference to FIGS. 6 and 14. The OCR model extracts textual content from the intermediate image and outputs a predicted text string. The predicted visual text may match, partially match, or diverge from the target visual text indicated in the input prompt. In some cases, the predicted visual text is used to compare to the display text from the text prompt (or input prompt) to generate a character recognition loss. This loss is used, during inference time, to update and guide the image generation to generate more accurate latent image features to align with the content described by the input prompt.

At operation 420, the system generates a synthetic image based on the target visual text and the predicted visual text, where the synthetic image depicts the target visual text. In some cases, the operations of this step refer to, or may be performed by, an image generation model as described with reference to FIGS. 6 and 14. For example, during the reverse diffusion process, the system applies gradients derived from a comparison of the predicted visual text and the target visual text, thereby refining latent features to improve text legibility and semantic accuracy. By iteratively applying this feedback at one or more timesteps in the diffusion process (e.g., a reverse diffusion process), the system enhances the alignment between the synthetic image and the target visual text, ensuring that the final output depicts text that is both readable and consistent with the input prompt.

FIG. 5 shows an example of text-to-image generation according to aspects of the present disclosure. The example shown includes image generation system 500, input prompt 505, machine learning model 510, and synthetic image 515. In some embodiments, the image generation system 500 is implemented in a user interface.

Referring to FIG. 5, image generation system 500 receives input prompt 505 and generates a synthetic image 515 using a machine learning model 510. In some embodiments, input prompt 505 includes one or more instructions describing visual content and target visual text to be depicted in the synthetic image 515. For example, the input prompt 505 may state, “Text ‘you're a gem.’ Fancy pastel iridescent star energy perfume bottle for woman, name ‘Victoria’, 3D render.” Based on the input prompt 505, the machine learning model 510 initiates a guided image generation process.

According to some embodiments, machine learning model 510 includes a text encoder configured to encode the input prompt 505 to obtain a text embedding. The machine learning model 510 further includes an image generation model that combines the text embedding with a noise input to generate the synthetic image 515. In some aspects, during the denoising process, the machine learning model 510 applies OCR-guided feedback (e.g., the character recognition loss) to guide the latent features to enhance the accuracy and legibility of the target visual text (e.g., “YOU'RE A GEM” and “Victoria”). The character recognition loss is computed by comparing the recognized text in an intermediate image generated by the image generation model with the target visual text, and the character recognition gradient is used to refine the image over predetermined diffusion timestep ranges.

In some embodiments, synthetic image 515 is generated based on the text embedding and the character recognition loss using the machine learning model 510. In some cases, the OCR guidance mechanism is used during inference and enhances the visual text based on feedback an OCR model. Embodiments of the present disclosure provide enhanced visual quality and semantic correctness of the generated text in synthetic images.

Conventional systems rely on classifier-free guidance or architecture-based constraints and are unable to render visually accurate and legible text in the output images. Conventional systems may generate output images that include artifacts or gibberish text that lacks semantic meaning. By contrast, image generation system 500 applies OCR-based character recognition gradients to generate synthetic image 515 with readable and coherent text aligned with the input prompt 505.

Input prompt 505 is an example of, or includes aspects of, the corresponding element described with reference to FIG. 6. Synthetic image 515 is an example of, or includes aspects of, the corresponding element described with reference to FIG. 6.

### System Architecture

In FIGS. 6-9 and 14-15, an apparatus and system for image processing include a memory component, and a processing device coupled to the memory component, the processing device configured to perform operations comprising: obtaining an input prompt indicating a target visual text, generating an intermediate image based on the input prompt, computing a character recognition loss based on the target visual text and the intermediate image, and generating a synthetic image based on the character recognition loss, where the synthetic image depicts the target visual text.

Some examples of the apparatus and system further include an optical character recognition (OCR) model configured to perform character recognition. Some examples of the apparatus and system further include a text encoder configured to encode the input prompt to obtain a text embedding, where the synthetic image is generated based on the text embedding. In some aspects, the image generation model comprises a diffusion model.

FIG. 6 shows an example of a machine learning model according to aspects of the present disclosure. The example shown includes machine learning system 600, input prompt 605, text encoder 610, text embedding 615, noise input 620, image generation model 625, image feature 630, decoder 635, intermediate image 640, display text 645, optical character recognition model (or OCR model 650), character recognition loss 655, and synthetic image 660. In some aspects, the machine learning system 600 includes a text encoder 610, image generation model 625, decoder 635, and OCR model 650. In some aspects, the image generation model 625 includes the text encoder 610 and the decoder 635.

Referring to FIG. 6, the machine learning system 600 generates a synthetic image 660 based on the input prompt 605. For example, the text encoder 610 generates text embedding 615 based on the input prompt. In some cases, the input prompt may state “a pink glass brain hovering above a box, with lightning coming from it, there is a sign that says, ‘think outside the box’, 3D render”. The text embedding 615 encodes the semantic attributes (e.g., object type, color, lighting, composition) and the target visual text (“think outside the box”), which is intended to be generated legibly in the synthetic image 660.

The image generation model 625 is initialized on noise input 620. In some cases, noise input 620 includes random noise or a noisy image. During the denoising process, the image generation model 625 generates an intermediate image 640 based on the text embedding 615. For example, the text embedding 615 may be combined with an intermediate image feature via a cross-attention layer, allowing the model to condition image synthesis on the visual scene and the target visual text. In some embodiments, a decoder 635 is used to decode the image feature 630 to obtain the intermediate image 640. In some cases, the decoder 635 coverts the image feature 630 from a latent space to the intermediate image 640 in a pixel space.

According to some embodiments, the image generation model 625 includes a diffusion model. In some aspects, diffusion models are a class of generative models that transform simple noise distributions into complex data distributions through a progressive denoising process. These models operate via two phases including a forward diffusion process and a reverser denoising process. For example, the forward diffusion process gradually adds noise to data samples, converting an initial data point x₀ into a sequence of increasingly noisy latent variables x₁, x₂, . . . , x_{T}. In one aspect, the noise follows a variance schedule β₁, β₂, . . . , β_{T}. The forward diffusion process can be represented as:

q(xₜ|xₜ₋₁):=N(xₜ;\sqrt{1−βₜx}ₜ₋₁,βₜI) (1)

In some aspects, the forward diffusion process represented above can be used to sample xₜ at an arbitrary timestep t without sequentially executing the entire forward diffusion process:

$$( {x}_{t} \vert {x}_{0} ) := N ( {x}_{t} ; \sqrt{{\overline{α}}_{t}} {x}_{0} , ( 1 - {\overline{α}}_{t} ) I ) \qquad ( 2 )$$

$$where {α}_{t} = 1 - {β}_{t} and {\overline{α}}_{t} = {\prod }_{i = 1}^{t} {α}_{i} .$$

During the reverse diffusion process, the diffusion model learns to remove the noise progressively through a Markov chain, starting from xₜ~N (0, I). In one aspect, the reverse diffusion process can be represented as:

$$p ( {x}_{t - 1} \vert {x}_{t} ) = N ( {x}_{t - 1} ; {μ}_{θ} ( {x}_{t} , t ) , {σ}_{t}^{2} I ) \qquad ( 3 )$$

where μ_{θ}(xₜ, t) is predicted using a neural network. This prediction can be represented as estimating the noise component in xₜ, where the training objective can be obtained and represented as:

$${ℒ}_{simple} = {𝔼}_{t , {x}_{0} , θ} [ {‖ ϵ - {ϵ}_{θ} ( {x}_{t} , t ) ‖}_{2}^{2} ] \qquad ( 4 )$$

where ϵ represents the noise added in the forward diffusion process, and ϵ_{θ}(xₜ, t) represents the predicted noise by the neural network.

In some aspects, the system uses classifier-free guidance configured to enhance the conditioning control without an additional classifier. The predicted noise of the classifier-free guidance can be represented as:

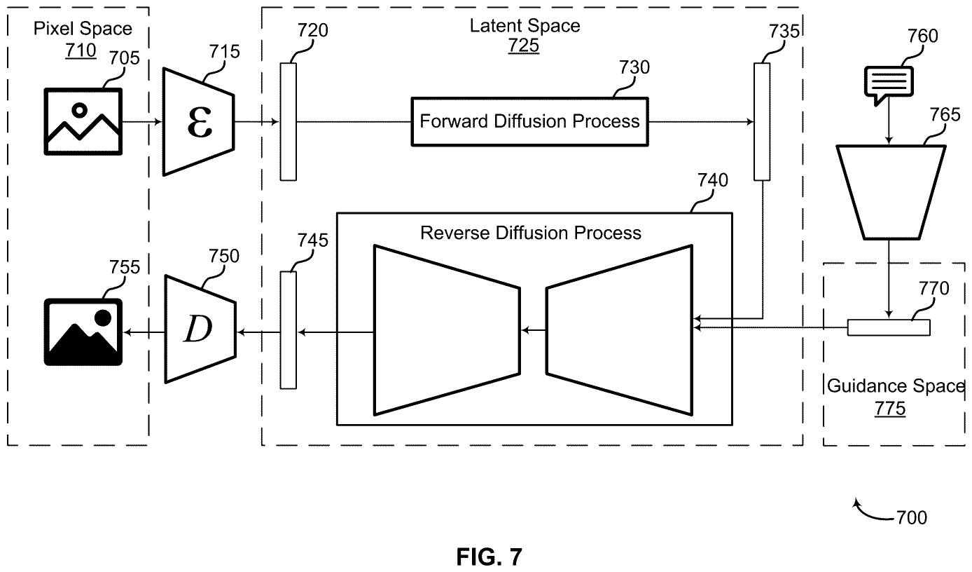

\hat{ϵ}_{θ}=ϵ_{θ}(xₜ,t,Ø)+w·(ϵ_{θ}(xₜ,t,c)−ϵ_{θ}(xₜ,t,Ø)) (5)

where x>1 represents a guidance scale, balancing the trade-off between adherence to conditioning information and sample diversity. Further detail on the image generation model 625 is described with reference to FIGS. 7-10.

In some embodiments, during the denoising process, OCR feedback may be provided to the image generation model 625 during the predetermined diffusion timesteps. For example, a display text 645 may be obtained from the input prompt 605, where the display text 645 depicts the target visual text to be generated in the synthetic image 660. For example, the display text 645 may state “think outside the box”. Then, the display text 645 and the intermediate image 640 are provided to the OCR model 650 to generate a character recognition loss 655. In some aspects, the character recognition loss 655 quantifies the discrepancy between the recognized text within the intermediate image 640 and the display text 645 described in the input prompt 605. In some aspects, the character recognition loss 655 is backpropagated to the image generation model 625 in the form of a gradient, which serves as a corrective signal for improving text legibility in subsequent timesteps. In some embodiments, the gradient (or OCR gradient) is converted to a latent space from the character recognition loss 655 in the pixel space.

In one aspect, the OCR feedback (or OCR guidance) is selectively applied during a diffusion timestep range, such as the mid-phase of the reverse diffusion process, where structural features of text are present but still malleable. This OCR guidance ensures computational efficiency while maximizing the influence of the OCR feedback on text refinement. In some cases, the character recognition gradient may be normalized to stabilize training dynamics and prevent excessive distortion of non-text elements within the image. By applying this feedback loop, the system incrementally adjusts the latent representation (e.g., the image feature 630) to resemble readable, semantically accurate text.

According to some embodiments, the machine learning system 600 uses an OCR-guided diffusion process to generate the synthetic image 660. The OCR model 650 generates an OCR loss (e.g., the character recognition loss 655) based on an intermediate image 640 and an input prompt 605. The OCR loss can be represented as:

[symbol]

_{OCR}(x,y)=CrossEntropy(f_{OCR}(x),y) (6)

where f_{OCR} represents a pre-trained model (e.g., the OCR model 650), x represents a generated image (e.g., an intermediate image 640 generated at an intermediate diffusion timestep), and y represents the display text 645 from the input prompt 605 (e.g., a text prompt).

At each timestep t during the reverse diffusion process, the system modifies the noise by adding a gradient term (e.g., the character recognition gradient in latent space) based on the OCR loss (from pixel space). In some cases, the character recognition gradient can be represented as:

\hat{ϵ}_{OCR}=\hat{ϵ}_{θ}−λₜ·∇ₓ_{ₜ} [symbol] _{OCR}(D(xₜ),y) (7)

where \hat{ϵ}_{θ} represents the noise prediction form the standard classifier-free guidance, λₜ represents the OCR guidance scale at timestep t, D(xₜ) is the decoded image from the latent representation xₜ, and ∇ₓ_{ₜ} represents the gradient with respect to the latent vector xₜ. According to some embodiments, the noise prediction may be used to initial the subsequent denoising process. In some cases, the noise prediction includes the image feature 630 or the intermediate image 640.

In some aspects, the OCR guidance scale λₜ can be represented as:

$${λ}_{t} = \{ \begin{matrix}λ , & if {t}_{min} \leq t \leq {t}_{max} \\ 0 , & otherwise\end{matrix} \qquad ( 8 )$$

where λ is a hyperparameter (e.g., the character recognition strength parameter) that controls the strength of the OCR guidance and [tₘᵢₙ, tₘₐₓ] represents the timestep range in which OCR guidance is applied. In some cases, the OCR guidance ensures that the guidance is applied during a specified timestep interval of the diffusion process, which balances between the controlled and adaptive text generation. In some cases, the OCR guidance may be applied to the entire reverse denoising process.

According to some embodiments, the system normalizes the character recognition loss 655 to stabilize the guidance process. For example, the system normalizes the character recognition gradient using:

$${∇}_{n o r m} = \frac{{∇}_{{x}_{t}} {ℒ}_{O C R} ( D ( {x}_{t} ) , y )}{{‖ {∇}_{{x}_{t}} {ℒ}_{O C R} ( D ( {x}_{t} ) , y ) ‖}_{2} + ε} \qquad ( 9 )$$

where ε is a small constant that prevents the normalization equation from dividing by zero. As a result, the noise prediction can be represented as:

\hat{ϵ}_{OCR}=\hat{ϵ}_{θ}−λₜ·∇ₙₒᵣₘ (10)

According to some embodiments, the system effectively integrates OCR-guided generation into a diffusion process without retraining the image generation model 625 (e.g., the diffusion model). As a result, the system can be used to augment existing text-to-image diffusion models. Additionally, the system improves the text renderings in diffusion-based text-to-image generation models.

According to some embodiments, the image generation model 625 may be guided using a latent OCR guidance. For example, the OCR model 650 may be configured to generate a latent character recognition loss (in latent space) based on the text embedding 615 and the image feature 630 at an intermediate diffusion timestep. The latent character recognition loss is used to steer the image generation process (e.g., represented by equation 6) towards generating an image feature (e.g., image feature 630) towards legible target visual text described in input prompt 605. In some cases, by computing the latent character recognition loss in latent space, the machine learning system 600 can increase the runtime efficiency by eliminating decoding process during the predetermined diffusion timestep range.

In some embodiments, the image generation model 625 generates an image feature 630 (e.g., image features without OCR guidance) based on the text embedding 615. In some cases, image feature 630 is a latent representation within the image generation model 625 that encodes visual and structural attributes of the synthetic image 660, including object layout, texture, color, and embedded text elements. In some embodiments, image feature 630 is generated as an intermediate output after applying the character recognition gradient derived from the OCR model 650.

The decoder 635 is configured to decode the image feature 630 (e.g., an image feature 630 at a final diffusion timestep) to generate the synthetic image 660. In some embodiments, the decoder 635 may include a variational autoencoder (VAE) decoder or similar neural network component trained to transform latent representations from latent space back into pixel-space. The decoder 635 reconstructs visual elements, including objects, textures, and text, based on the refined latent features encoded within image feature 630. In some cases, image feature 630 may include high-level information influenced by both the input prompt 605 and the character recognition gradient applied during the diffusion process. In some cases, synthetic image 660 depicts visually rich scene and legible target visual text described by the input prompt 605.

According to some embodiments, the system includes a decoder configured to decode the image feature to generate the synthetic image. For example, the decoder can perform operations using a decoding function D(xₜ) configured to convert the latent image feature (or representation) to a synthetic image as:

D(xₜ)=VAE_{decoder}(xₜ⊙(σ+μ) (11)

where σ and μ represent the standard deviation and mean, respectively, of the latent space, and ⊙ represents the element-wise multiplication.

According to some embodiments, the impact of OCR guidance on the synthetic image can be quantified. For example, how the OCR gradient propagates through the reverse diffusion process can be analyzed based on the method described below. In some cases, the influence of OCR gradient at timestep t on the synthetic image x₀ can be represented as:

$$Δ {x}_{0} = {\sum }_{t = {t}_{min}}^{{t}_{max}} {𝒥}_{t} \cdot {λ}_{t} {∇}_{norm}^{t} \qquad ( 12 )$$

where Δx₀ represents the total change in the final image (e.g., the synthetic image 660 or an intermediate image 640) based on the OCR guidance. The term [symbol] ₜ is the Jacobian that maps the gradient changes at timestep t to changes in the final image. The term λₜ is the OCR guidance scale at timestep t. The term

$${∇}_{norm}^{t}$$

represents the normalized OCR gradient at timestep t.

In some aspects, a scheduler in a diffusion model controls the denoising steps during image generation. The scheduler determines how noise is gradually removed over time. The scheduler defines the pace and method of this reverse process which guides the quality, style, and speed of the final image. For example, the scheduler in the sampling process can be represented as:

$$( 13 )$$

$${x}_{t - 1} = \sqrt{{α}_{t - 1}} ( \frac{{x}_{t} - \sqrt{1 - {α}_{t}} \cdot {ϵ}_{θ} ( {x}_{t} , t )}{\sqrt{{α}_{t}}} ) + \sqrt{1 - {α}_{t - 1} - {σ}_{t}^{2}} \cdot {ϵ}_{θ} ( {x}_{t} , t ) + {σ}_{t} {ϵ}_{t}$$

where σₜ represents the sampling variance (e.g., a DDIM sampling variance) and the Et represents random noise. For deterministic sampling, where σₜ=0, the system can compute:

$$\frac{\partial {x}_{t - 1}}{\partial {x}_{t}} \approx - \sqrt{\frac{{α}_{t - 1}}{{α}_{t}}} ( 1 - \sqrt{1 - {α}_{t}} ) + \sqrt{1 - {α}_{t - 1}} \qquad ( 14 )$$

In some cases, the Jacobian [symbol] ₜ can be computed as a product of the stepwise derivative from xₜ down to x₁, which maps the changes at timestep t to changes in the final image x₀. Accordingly, the transformation of the Jacobian [symbol] ₜ can be expanded as:

$${𝒥}_{t} = \frac{\partial {x}_{0}}{\partial {x}_{t}} \approx {\prod }_{i = t}^{1} \frac{\partial {x}_{t - 1}}{\partial {x}_{t}} \approx {\prod }_{i = t}^{1} ( - \sqrt{\frac{{α}_{t - 1}}{{α}_{t}}} ( 1 - \sqrt{1 - {α}_{t}} ) + \sqrt{1 - {α}_{t - 1}} ) \qquad ( 15 )$$

where αᵢ represents the noise schedule parameters.

In some cases, the perceptual impact of the OCR guidance can be represented by measuring the enhancement in the OCR confidence between guided and unguided generations, which can be represented as:

$${𝒥}_{O C R} = log ( \frac{{P}_{OCR} ( y \vert {x}_{0}^{g u i d e d} )}{{P}_{OCR} ( y \vert {x}_{0}^{u n g u i d e d} )} ) \qquad ( 16 )$$

where [symbol] _{OCR} is the improvement in OCR confidence, P_{OCR} (y|x) represents the probability assigned by the OCR model to the target text y based on an image

$$x \cdot {x}_{0}^{g u i d e d}$$

represents the synthetic image generated with OCR guidance and

$${x}_{0}^{u n g u i d e d}$$

represents the synthetic image without OCR guidance.

In some aspects, the impact of the OCR guidance is effective during the middle timesteps ([tₘᵢₙ, tₘₐₓ]) of the diffusion process. During this period, the image structure is formed but some details are still malleable. The early timesteps have higher Jacobian influence but lack sufficient structure for OCR feedback. During the later timesteps, the image generation model generates clear text features but does not have enough diffusion timesteps remaining for additional changes.

According to some embodiments, the system may enhance the OCR guidance by applying multiple iterations of gradient descent on the OCR loss at each diffusion timestep. For example, at each timestep t in the reverse diffusion process, the system performs Nₜ iterations of the OCR gradient updates:

$${x}_{t}^{0} = {x}_{t} .$$

Then, ∀i∈[1, Nₜ], where the latent representation (e.g., an intermediate image feature) can be represented as:

$${x}_{t}^{i} = {x}_{t}^{i - 1} - {ξ}_{t} \cdot {∇}_{norm}^{i} \qquad ( 17 )$$

$${∇}_{norm}^{i} = \frac{{∇}_{OCR}^{i}}{{‖ {∇}_{OCR}^{i} ‖}_{2} + ε} \qquad ( 18 )$$

$${∇}_{OCR}^{i} = {∇}_{{x}_{t}^{i - 1}} {ℒ}_{OCR} ( D ( {x}_{t}^{i - 1} ) , y ) \qquad ( 19 )$$

where Nₜ represents the number of OCR optimization iterations at timestep t,

$${x}_{t}^{i}$$

represents the latent representation after i iterations of OCR guidance, ξₜ represents the step size for OCR gradient updates. In some cases, the ξₜ can be different from λₜ.

$${∇}_{OCR}^{i}$$

represents the OCR gradient at iteration i and

$${\hat{ϵ}}_{O C R} = {ϵ}_{θ} ( {x}_{t}^{{N}_{t}} , t , c ) .$$

is the normalized gradient at iteration i. In some embodiments, the system applies the standard noise prediction after Nₜ iterations, where the predicted noise can be represented as

$${∇}_{n o r m}^{i}$$

In some aspects, the number of iterations can be dynamically computed based on an OCR loss enhancement, which is represented as:

$${N}_{t} = min \{ {N}_{max} , min \{ n ∈ N \vert {ℒ}_{O C R} ( D ( {x}_{t}^{n} ) , y ) < τ \cdot {ℒ}_{O C R} ( D ( {x}_{t}^{0} ) , y ) \} \} \qquad ( 20 )$$

where Nₘₐₓ represents the maximum number of iterations, and τ∈(0,1) is a threshold number for determining the enhancement.

Input prompt 605 is an example of, or includes aspects of, the corresponding element described with reference to FIG. 5. Text encoder 610 is an example of, or includes aspects of, the corresponding element described with reference to FIGS. 7 and 14. Image generation model 625 is an example of, or includes aspects of, the corresponding element described with reference to FIG. 14.

OCR model 650 is an example of, or includes aspects of, the corresponding element described with reference to FIG. 14. Synthetic image 660 is an example of, or includes aspects of, the corresponding element described with reference to FIG. 5.

FIG. 7 shows an example of an image generation model according to aspects of the present disclosure. The example shown includes diffusion model 700, original image 705, pixel space 710, image encoder 715, original image feature 720, latent space 725, forward diffusion process 730, noisy feature 735, reverse diffusion process 740, denoised image feature 745, image decoder 750, output image 755, text prompt 760, text encoder 765, guidance feature 770, and guidance space 775.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image, or to image features generated by an encoder (e.g., latent diffusion).

Diffusion models work by iteratively adding noise to the data during a forward process and then learning to recover the data by denoising the data during a reverse process. For example, during training, diffusion model 700 may take an original image 705 in a pixel space 710 as input and apply an image encoder 715 to convert original image 705 into original image feature 720 in a latent space 725. Then, a forward diffusion process 730 gradually adds noise to the original image feature 720 to obtain noisy feature 735 (also in latent space 725) at various noise levels.

Next, a reverse diffusion process 740 (e.g., a U-Net ANN) gradually removes the noise from the noisy feature 735 at the various noise levels to obtain the denoised image feature 745 in latent space 725. In some examples, denoised image feature 745 is compared to the original image feature 720 at each of the various noise levels, and parameters of the reverse diffusion process 740 of the diffusion models are updated based on the comparison. Finally, an image decoder 750 decodes the denoised image feature 745 to obtain an output image 755 in pixel space 710. In some cases, an output image 755 is created at each of the various noise levels. The output image 755 can be compared to the original image 705 to train the reverse diffusion process 740. In some cases, output image 755 refers to the synthetic image (e.g., described with reference to FIGS. 5-6).

In some cases, image encoder 715 and image decoder 750 are pre-trained prior to training the reverse diffusion process 740. In some examples, image encoder 715 and image decoder 750 are trained jointly, or the image encoder 715 and image decoder 750 are fine-tuned jointly with the reverse diffusion process 740.

The reverse diffusion process 740 can also be guided based on a text prompt 760, or another guidance prompt, such as an image, a layout, a style, a color, a segmentation map, etc. The text prompt 760 can be encoded using a text encoder 765 (e.g., a multimodal encoder) to obtain guidance feature 770 in guidance space 775. The guidance feature 770 can be combined with the noisy feature 735 at one or more layers of the reverse diffusion process 740 to ensure that the output image 755 includes content described by the text prompt 760. For example, guidance feature 770 can be combined with the noisy feature 735 using a cross-attention block within the reverse diffusion process 740.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, enabling the machine learning model to understand the context and generate more accurate and contextually relevant outputs.

In some examples, diffusion models are based on a neural network architecture known as a U-Net. The U-Net takes input features having an initial resolution and an initial number of channels and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

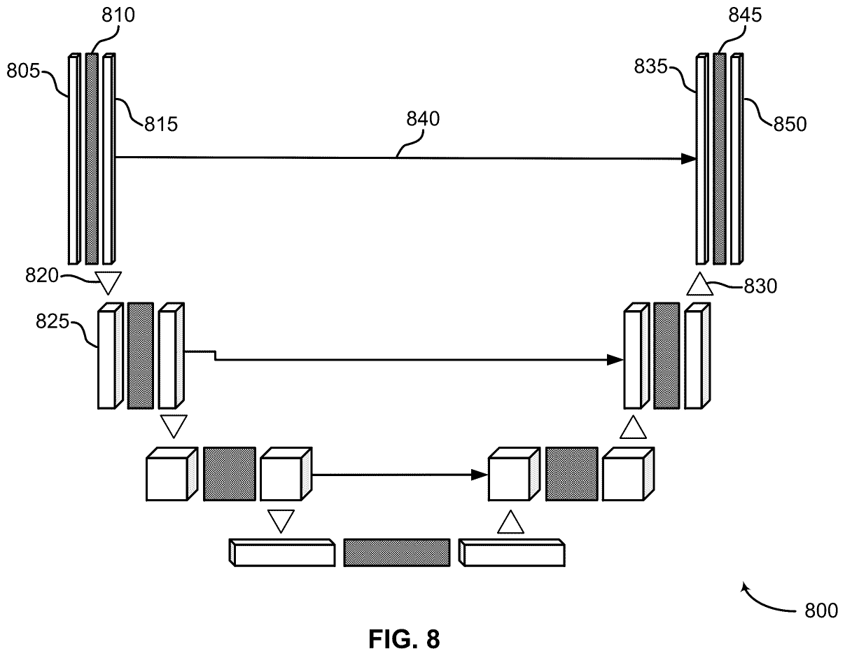

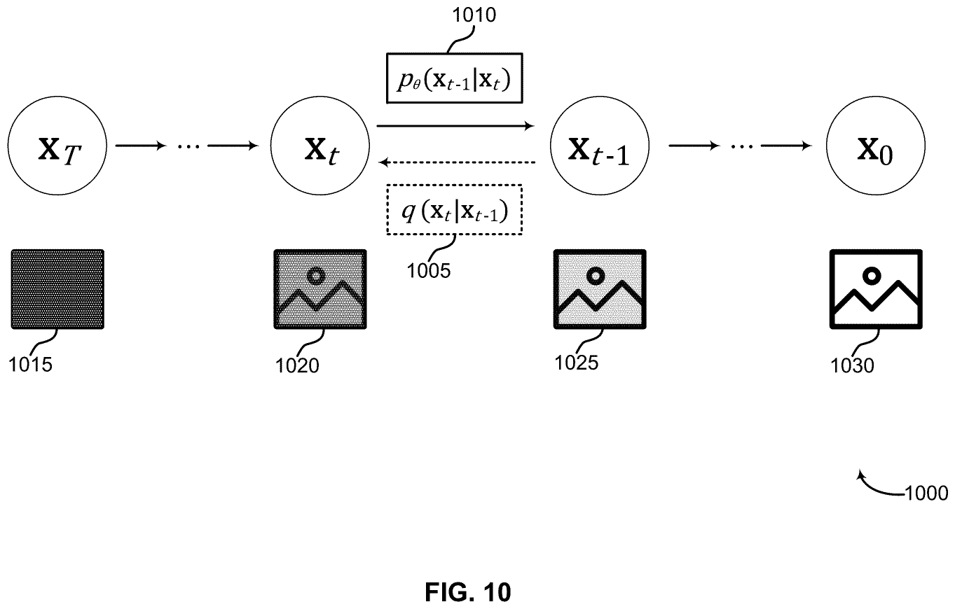

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features. Further detail on the U-Net is described with reference to FIGS. 8 and 10.

A diffusion process may also be modified based on conditional guidance. In some cases, a user provides a text prompt (e.g., text prompt 760) describing content to be included in a generated image. In some examples, guidance can be provided in a form other than text, such as via an image, a sketch, a color, a style, or a layout. The system converts text prompt 760 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 700 generates an image based on the noise map and the conditional guidance vector.

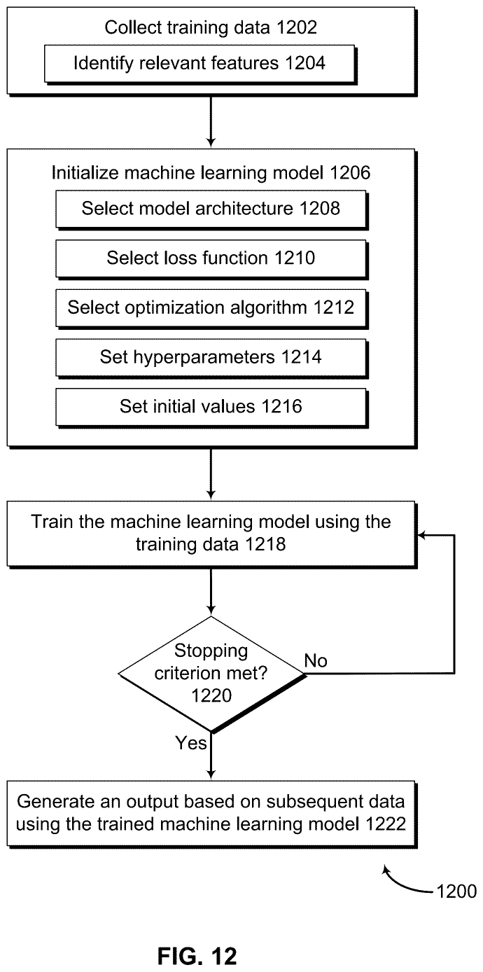

A diffusion process can include both a forward diffusion process 730 for adding noise to an image (e.g., original image 705) or features (e.g., original image feature 720) in a latent space 725 and a reverse diffusion process 740 for denoising the images (or features) to obtain a denoised image (e.g., output image 755). The forward diffusion process 730 can be represented as q(xₜ|xₜ₋₁), and the reverse diffusion process 740 can be represented as p_{θ}(xₜ₋₁|xₜ). Further detail on the diffusion process is described with reference to FIG. 12.

A diffusion model 700 may be trained using both a forward diffusion process 730 and a reverse diffusion process 740. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 730 in N stages. In some cases, the forward diffusion process 730 is a fixed process where Gaussian noise is successively added to an image. In latent diffusion models, the Gaussian noise may be successively added to features (e.g., original image feature 720) in a latent space 725.

At each stage n, starting with stage N, a reverse diffusion process 740 is used to predict the image or image features at stage n-1. For example, the reverse diffusion process 740 can predict the noise that was added by the forward diffusion process 730, and the predicted noise can be removed from the image to obtain the predicted image. In some cases, an original image 705 is predicted at each stage of the training process.

The training component compares predicted image (or image features) at stage n-1 to an actual image (or image features), such as the image at stage n-1 or the original input image. For example, given observed data x, the diffusion model 700 may be trained to minimize the variational upper bound of the negative log-likelihood −log p_{θ}(x) of the training data. The training component then updates parameters of the diffusion model 700 based on the comparison. For example, parameters of a U-Net may be updated using gradient descent. Time-dependent parameters of the Gaussian transitions can also be learned. Further detail on training the diffusion model is described with reference to FIG. 13.

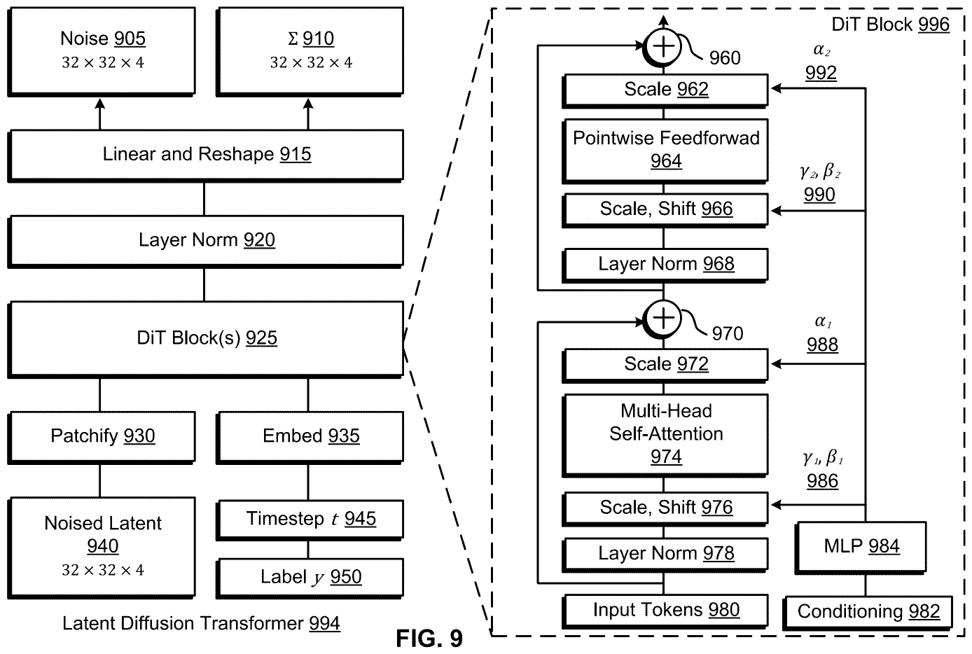

Original image 705 is an example of, or includes aspects of, the corresponding element described with reference to FIG. 9. Forward diffusion process 730 is an example of, or includes aspects of, the corresponding element described with reference to FIG. 9. Reverse diffusion process 740 is an example of, or includes aspects of, the corresponding element described with reference to FIG. 10.

text prompt 760 is an example of, or includes aspects of, the input prompt described with reference to FIG. 5-6. Text encoder 765 is an example of, or includes aspects of, the corresponding element described with reference to FIGS. 6 and 14.

FIG. 8 shows an example of a U-Net 800 architecture according to aspects of the present disclosure. The example shown includes U-Net 800, input feature 805, initial neural network layer 810, intermediate feature 815, down-sampling layer 820, down-sampled feature 825, up-sampling process 830, up-sampled feature 835, skip connection 840, final neural network layer 845, and output feature 850.

In some examples, U-Net 800 is an example of the component that performs the reverse diffusion process 740 of diffusion model 700 described with reference to FIG. 7 and includes architectural elements of the image generation model 1430 described with reference to FIG. 14. The U-Net 800 depicted in FIG. 8 is an example of, or includes aspects of, the architecture used within the reverse diffusion process described with reference to FIG. 7.

In some examples, diffusion models are based on a neural network architecture known as a U-Net. The U-Net 800 takes input feature 805 having an initial resolution and an initial number of channels and processes the input feature 805 using an initial neural network layer 810 (e.g., a convolutional network layer) to produce intermediate feature 815. The intermediate feature 815 is then down-sampled using a down-sampling layer 820 such that the down-sampled feature 825 has a resolution less than the initial resolution and a number of channels greater than the initial number of channels.

This process is repeated multiple times, and then the process is reversed. For example, the down-sampled feature 825 is up-sampled using up-sampling process 830 to obtain up-sampled feature 835. The up-sampled feature 835 can be combined with intermediate feature 815 having the same resolution and number of channels via a skip connection 840. These inputs are processed using a final neural network layer 845 to produce output feature 850. In some cases, the output feature 850 has the same resolution as the initial resolution and the same number of channels as the initial number of channels.

In some cases, U-Net 800 takes an additional input feature to produce conditionally generated output. For example, the additional input feature could include a vector representation of an input prompt. The additional input feature can be combined with the intermediate feature 815 within the neural network at one or more layers. For example, a cross-attention module can be used to combine the additional input features and the intermediate feature 815.

FIG. 9 shows an example of a diffusion transformer model according to aspects of the present disclosure. The example shown includes predicted noise 905, predicted covariance 910, linear and reshape layers 915, normalization layer 920, DiT block(s) 925, patchify operation 930, embedding 935, noised latent 940, timestep information 945, label information 950, and an implementation of one block in the DiT block(s) 925 by a DiT Block 996. In one aspect, the DiT Block 996 includes second residual connection 960, second scaling operations 962, feed-forward network 964, post-normalization second scaling and shifting 966, second normalization 968, first residual connection 970, first scaling operations 972, self-attention 974, post-normalization first scaling and shifting 976, first normalization 978, input tokens 980, conditioning tokens 982, multi-layer perceptron (or MLP 984), post-normalization first scaling and shifting parameters 986, first scaling parameter 988, post-normalization second scaling and shifting parameters 990, and second scaling parameter 992. In some embodiments, the architecture uses a Latent Diffusion Transformer 994. In some embodiments, DiT Block 996 uses an “adaLN-Zero” technique.

Diffusion Transformers (DiTs) is a popular architecture for diffusion models and is designed to be structurally faithful to standard transformer architecture. DiT incorporates the scaling properties of the transformer structures. For training denoising diffusion probabilistic models (DDPMs) of images (e.g., spatial representations of images), DiT is based on a Vision Transformer (ViT) architecture which operates on sequences of patches. DiT processes images by dividing the images into patches, converting these patches into tokens, and applying attention mechanisms to model relationships between different regions of the image. This approach enables the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p quadruples T, which in some cases at least quadruples total of transformer Giga Floating Point Operations (Gflops). In some examples, changing p has no impact on downstream parameter counts, e.g., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x→x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all as; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks, large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into the original spatial layout to get the predicted noise and covariance.

The diffusion transformer model, in some cases, employs a Latent Diffusion Transformer 994. The diffusion transformer model processes noised latent 940, which may be a noised version of an input image encoded in a latent space. Patchify operation 930 divides the noised latent into a sequence of patches that are processed as tokens. The tokens are vector representations of each patch of the image in latent space and are adjusted through attention processes. Each of the tokens also receives timestep information 945 and label information 950 and the embedding 935 encodes the current denoising timestep and class labels as conditional information. In some cases, embedding 935 is referred to as conditional embedding or conditional information embedding. In some cases, a positional embedding which encodes each token's spatial position in the image is applied to the patchified input tokens at the patchify operation 930. In some examples the positional embedding is ViT frequency-based positional embedding. The input tokens 980 generated by the patchify operation 930 and the conditioning tokens 982 generated by the embedding 935 are processed through N DiT block(s) 925, where N may be 92, 24 or 28. Other values of N may be used. In some cases, conditional tokens refer to tokens generated based on embedding 935, encoding timestep information 945, and label information 950.

Each of the DiT block(s) 925 includes multiple processing stages. DiT Block 996 illustrates an embodiment of one block in the DiT block(s) 925. In some embodiments, the DiT Block 996 is an example of, or includes aspects of, the adaLN-Zero block. In some cases, input tokens 980 interact with the conditioning tokens 982 through multiple attention mechanisms. Particularly, after first normalization 978 applied to the input tokens and MLP 984 to the conditional tokens, MLP 984 generates or updates post-normalization first scaling and shifting parameters 986, denoted as γ₁, β₁, for post-normalization first scaling and shifting 976 to scale and shift the output of first normalization 978 accordingly. As the normalized input tokens obtained from first normalization 978 are scaled and shifted at post-normalization first scaling and shifting 976 using the conditional information carried as least in γ₁, β₁, this enables the input information and conditional information to interact. Self-attention 974 enables the scaled and shifted normalized input tokens, namely the output from post-normalization first scaling and shifting 976, to attend to each other. MLP 984 also generates or updates first scaling parameter 988 denoted as α₁ for first scaling operations 972 to scale the output of self-attention 974 (e.g., multi-head self-attention), further interacting the input information and conditional information. The input tokens 980 is then summed with the output of first scaling operations 972 at first residual connection 970. In some examples, α₁ has initial values 0, and the DiT Block 996 is initialized as the identity function.

A similar process is performed in a second half of the DiT Block 996. MLP 984 generates or updates post-normalization second scaling and shifting parameters 990, denoted as γ₂, β₂, for post-normalization second scaling and shifting 966 to scale and shift the output of second normalization 968 accordingly. As the output from second normalization 968 is scaled and shifted using the conditional information carried at least in γ₂, β₂, this allows the input information and conditional information to further interact. Feed-forward network 964 then processes the scaled and shifted output from post-normalization second scaling and shifting 966. MLP 984 also generates or updates the second scaling parameter 992 denoted as α₂ for second scaling operations 962 to scale the output of feed-forward network 964, further interacting with the input information and conditional information. In some cases, the feed-forward network 964 is a pointwise feed-forward network. The output from first residual connection 970 is then summed with the output of second scaling operations 962 at second residual connection 960, and the result is the final output of DiT Block 996. In some examples, α₂ has initial values 0, and the DiT Block 996 is initialized as the identity function. This process repeats for each DiT block in the sequence.

After processing through all DiT block(s) 925, the outputs undergo normalization layer 920 followed by linear and reshape layers 915. The final output is the predicted noise 905, which represents the model's prediction of the noise that was added to initially create the noised latent 940, and the predicted covariance 910, which represents the model's prediction of the covariance. The predicted noise 905 is removed from noised latent 940 at each diffusion timestep, and the predicted covariance may affect how noise is removed or resampled in the reverse or denoising process. At the end of the denoising schedule, the latent sample is decoded to generate the synthetic image in pixel space.

### Diffusion Process

FIG. 10 shows an example of a diffusion process 1000 according to aspects of the present disclosure. The example shown includes diffusion process 1000, forward diffusion process 1005, reverse diffusion process 1010, noisy image 1015, first intermediate image 1020, second intermediate image 1025, and original image 1030.

Diffusion process 1000 can include forward diffusion process 1005 for adding noise to original image 1030 (e.g., original image 705 described with reference to FIG. 7) or features (e.g., original image feature 720 described with reference to FIG. 7) in a latent space. In some aspects, diffusion process 1000 includes reverse diffusion process 1010 for denoising the noisy image 1015 (or image features) to obtain a denoised image (or original image 1030). The forward diffusion process 1005 can be represented as q(xₜ|xₜ₋₁), and the reverse diffusion process 1010 can be represented as p_{θ}(xₜ₋₁|xₜ). In some cases, the forward diffusion process 1005 is used during training to generate images with successively greater noise, and a neural network is trained to perform the reverse diffusion process 1010 (e.g., to successively remove the noise).

In an example forward diffusion process 1005 for a latent diffusion model (e.g., diffusion model 700 described with reference to FIG. 7), the diffusion model maps an observed variable x, (either in a pixel space or a latent space) to obtain intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 1010. During the reverse diffusion process 1010, the diffusion model begins with noisy data x_{T}, such as a noisy image 1015 and denoises the data to obtain the p_{θ}(xₜ₋₁|xₜ). At each step t-1, the reverse diffusion process 1010 takes xₜ, such as the first intermediate image 1020, and t as input. Here, t represents a step in the sequence of transitions associated with different noise levels, The reverse diffusion process 1010 outputs xₜ₋₁, such as the second intermediate image 1025, iteratively until x_{T} is reverted back to x₀, the original image 1030. The reverse diffusion process 1010 can be represented as:

p_{θ}(xₜ₋₁|xₜ):=N(xₜ₋₁;μ_{θ}(xₜ,t),Σ_{θ}(xₜ,t)). (21)

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 22 )$$

where p(x_{T})=N(x_{T}; 0, I) is the pure noise distribution as the reverse diffusion process 1010 takes the outcome of the forward diffusion process 1005, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

Forward diffusion process 1005 is an example of, or includes aspects of, the corresponding element described with reference to FIG. 7. Reverse diffusion process 1010 is an example of, or includes aspects of, the corresponding element described with reference to FIG. 7. Original image 1030 is an example of, or includes aspects of, the corresponding element described with reference to FIG. 7.

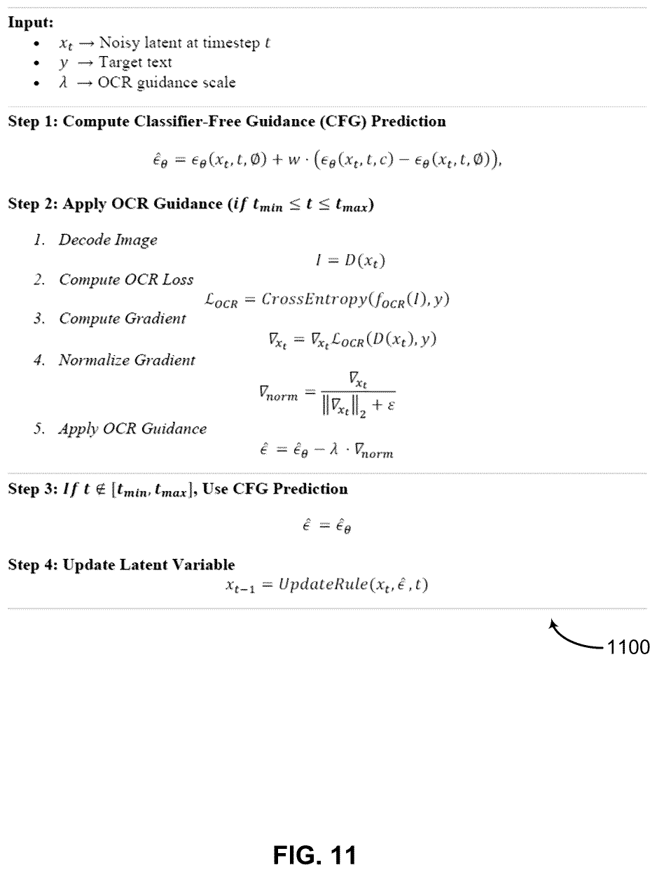

FIG. 11 shows an example of a pseudocode for OCR-guided diffusion according to aspects of the present disclosure. The example shown includes pseudocode 1100. In some cases, pseudocode represents a simplified version of an algorithm using plain language and basic programming concepts. Pseudocode 1100 is used to plan and communicate logic before actual coding. In some cases, embodiments of the present disclosure may be implemented using various types of code or programming languages, without departing from the spirit of the underlying principles.

Referring to FIG. 11, the pseudocode 1100 outlines an algorithm that integrates OCR guidance into the denoising process of a diffusion model (e.g., the image generation model described with reference to FIG. 6) to enhance text legibility in image generation. The model receives inputs including a noisy latent input at a predetermined timestep, a target text (e.g., the target visual text) described by the input prompt, and an OCR guidance scale (e.g., a character recognition strength parameter). The algorithm guides the model toward generating a synthetic image that matches a target visual text using classifier-free guidance and OCR-based feedback.

In the first step, the algorithm computes a classifier-free guidance (CFG) prediction. For example, the model combines the output conditioned on the target and unconditioned inputs of the denoising network, scaled by a guidance weight (e.g., w). This step provides a baseline prediction that enhances alignment with the target visual text without external feedback.

The second step is to apply OCR guidance during a predetermined range of timesteps. If the current timestep falls within the predetermined range, the algorithm decodes the latent variable into an image, computes the OCR loss between the recognized text in the image and the target text described by the input prompt, and then calculates the gradient of this loss with respect to the latent input. The gradient is normalized to control the scale and then used to adjust the CFG prediction. The adjustment helps control the generation toward generating text that more matches the input prompt.

If the timestep is outside the designated range, the algorithm skips the OCR feedback and simply uses the CFG prediction. This allows for flexibility in how much influence the OCR guidance has throughout the sampling process (or the denoising process).

Then, the latent variable is updated using a rule-based algorithm. Accordingly, the pseudocode 1100 enables the diffusion model to incorporate textual accuracy into the image generation process, enabling the image generation model to generate synthetic image that accurately depict the target visual text described by the input prompt.

### Training and Evaluation

FIG. 12 shows an example of a flow diagram depicting an algorithm as a step-by-step procedure in an example implementation of operations performable for training a machine learning model according to aspects of the present disclosure. In some embodiments, the procedure 1200 describes an operation of the training component described for training the image generation model. The procedure 1200 provides one or more examples of generating training data, use of the training data to train a machine-learning model, and use of the trained machine-learning model to perform a task.

To begin in this example, a machine-learning system collects training data (block 1202) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1204) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1206). Initialization of the machine-learning model includes selecting a model architecture (block 1208) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1210). The loss function is utilized to measure a difference between an output of the machine-learning model (e.g., the model predictions) and target values (e.g., as expressed by the training data) to be used to train the machine-learning model. Additionally, an optimization algorithm is selected (block 1212) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1216) examples of which include initializing weights and biases of nodes to increase efficiency in training and computational resources consumption as part of training. Hyperparameters are also set (block 1214) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1218) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1220), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), procedure 1200 continues the training of the machine-learning model using the training data (block 1218) in this example.

If the stopping criterion is met (“yes” from decision block 1220), the trained machine-learning model is then utilized to generate an output based on subsequent data (block 1222). The trained machine-learning model, for instance, is trained to perform a task as described above and therefore, once trained is configured to perform that task based on subsequent data received as an input and processed by the machine-learning model.

FIG. 13 shows an example of a method 1300 for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

In some embodiments, the method 1300 describes an operation of a training component described for training the image generation model. The method 1300 represents an example for training a reverse diffusion process as described above with reference to FIG. 10. In some examples, these operations are performed by a system including a processor executing a set of codes to control functional elements of an apparatus, such as the image generation model described in FIG. 14.

At operation 1305, the system initializes untrained model. In some cases, the operations of this step refer to, or may be performed by, a training component as described with reference to FIG. 14. Initialization can include defining the architecture of the model and establishing initial values for the model parameters. In some cases, the initialization can include defining hyper-parameters such as the number of layers, the resolution and channels of each layer block, the location of skip connections, and the like.

At operation 1310, the system adds noise to media item using forward diffusion process in N stages. In some cases, the operations of this step refer to, or may be performed by, a training component as described with reference to FIG. 14. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1315, the system at each stage n, starting with stage N, predict media item for stage n-1. In some cases, the operations of this step refer to, or may be performed by, a training component as described with reference to FIG. 14. In some cases, the media item is a synthetic image generated using the image generation model. For example, the reverse diffusion process can predict the noise that was added by the forward diffusion process, and the predicted noise can be removed from the noise input to obtain the predicted output. In some cases, an original media item is predicted at each stage of the training process.

At operation 1320, the system compares the predicted media item (or feature) at stage n-1 to media at stage n-1. In some cases, for example, the system compares the synthetic image (or predicted image feature) at state n-1 to the ground-truth image (or ground-truth feature) at state n-1. In some cases, the operations of this step refer to, or may be performed by, a training component as described with reference to FIG. 14. For example, given observed data x, the diffusion model may be trained to minimize the variational upper bound of the negative log-likelihood −log p_{θ}(x) of the training data.

At operation 1325, the system updates parameters of the model based on the comparison. In some cases, the operations of this step refer to, or may be performed by, a training component as described with reference to FIG. 14. For example, parameters of a U-Net may be updated using gradient descent. Time-dependent parameters of the Gaussian transitions can also be learned.

### System Apparatus

FIG. 14 shows an example of an image processing apparatus 1400 according to aspects of the present disclosure. The example shown includes image processing apparatus 1400, processor unit 1405, I/O module 1410, and memory unit 1415. In one aspect, memory unit 1415 includes text encoder 1420, optical character recognition model 1425, and image generation model 1430.

According to some embodiments of the present disclosure, image processing apparatus 1400 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 1400 is an example of, or includes aspects of, the corresponding element described with reference to FIG. 1.

Processor unit 1405 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 1405 is configured to operate a memory array using a memory controller. In other cases, a memory controller is integrated into the processor. In some cases, processor unit 1405 is configured to execute computer-readable instructions stored in a memory to perform various functions. In some embodiments, processor unit 1405 includes special-purpose components for modem processing, baseband processing, digital signal processing, or transmission processing. Processor unit 1405 is an example of, or includes aspects of, the processor described with reference to FIG. 15.

I/O module 1410 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 1410 includes a user interface. A user interface may enable a user to interact with a device. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 1410 is an example of, or includes aspects of, the I/O interface described with reference to FIG. 15.

Examples of memory unit 1415 include random access memory (RAM), read-only memory (ROM), or a hard disk. Examples of memory unit 1415 include solid-state memory and a hard disk drive. In some examples, memory unit 1415 is used to store computer-readable, computer-executable software including instructions that, when executed, cause a processor to perform various functions described herein.

In some cases, memory unit 1415 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 1415 store information in the form of a logical state.

In one aspect, memory unit 1415 includes a machine learning model. The machine learning model includes text encoder 1420, optical character recognition model 1425, and image generation model 1430. Memory unit 1415 is an example of, or includes aspects of, the memory subsystem described with reference to FIG. 15.

In some cases, a machine learning model is a computational algorithm, model, or system designed to recognize patterns, make predictions, or perform a specific task (for example, image processing) without being explicitly programmed. According to some aspects, the machine learning model is implemented as software stored in memory unit 1415 and executable by processor unit 1405, as firmware, as one or more hardware circuits, or as a combination thereof.

According to some embodiments of the present disclosure, machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge are associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, machine learning model includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, a machine learning model includes machine learning parameters. Machine learning parameters, also known as model parameters or weights, are variables that provide behavior and characteristics of machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, a machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, a machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important.

The attention mechanism involves a query, keys, and values denoted by Q, K, and V, respectively. Q is a matrix that contains the query (vector representation of one word in the sequence), K are the keys (vector representations of the words in the sequence), and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, which allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, text encoder 1420 is implemented as software stored in memory unit 1415 and executable by processor unit 1405, as firmware, as one or more hardware circuits, or as a combination thereof. According to some aspects, text encoder 1420 is configured to encode the input prompt to obtain a text embedding, where the synthetic image is generated based on the text embedding. Text encoder 1420 is an example of, or includes aspects of, the corresponding element described with reference to FIGS. 5 and 6.

According to some aspects, optical character recognition model 1425 is implemented as software stored in memory unit 1415 and executable by processor unit 1405, as firmware, as one or more hardware circuits, or as a combination thereof. According to some aspects, optical character recognition model 1425 computes a character recognition loss based on the target visual text. In some examples, optical character recognition model 1425 performs character recognition on the intermediate image to obtain intermediate visual text. In some examples, optical character recognition model 1425 compares the intermediate visual text to the target visual text.

In some examples, optical character recognition model 1425 computes a character recognition gradient based on the character recognition loss, where the noise input is denoised based on the character recognition gradient. In some examples, optical character recognition model 1425 obtains a character recognition strength parameter indicating a target strength of the character recognition loss, where the character recognition loss is applied based on the character recognition strength parameter. In some examples, optical character recognition model 1425 normalizes the character recognition loss 555 to obtain a normalized character recognition loss, where the synthetic image is generated based on the normalized character recognition loss. Optical character recognition model 1425 is an example of, or includes aspects of, the corresponding element described with reference to FIG. 6.

According to some aspects, image generation model 1430 is implemented as software stored in memory unit 1415 and executable by processor unit 1405, as firmware, as one or more hardware circuits, or as a combination thereof. According to some aspects, image generation model 1430 obtains an input prompt indicating a target visual text. In some examples, image generation model 1430 generates a synthetic image based on the input prompt and the character recognition loss, where the synthetic image depicts the target visual text.

In some examples, image generation model 1430 generates an intermediate image based on the input prompt. In some examples, image generation model 1430 obtains a noise input. In some examples, image generation model 1430 denoises the noise input based on the character recognition loss. In some examples, image generation model 1430 identifies a diffusion timestep range, where the character recognition loss is applied within the diffusion timestep range. In some examples, image generation model 1430 computes classifier free guidance based on the character recognition loss 555.

According to some aspects, image generation model 1430 comprise obtains an input prompt indicating a target visual text. In some examples, image generation model generates a synthetic image based on the input prompt and the character recognition loss, where the synthetic image depicts the target visual text. In some aspects, the image generation model 1430 includes a diffusion model. In some cases, the diffusion model includes a U-Net architecture. In some aspects, the image generation model 1430 includes a diffusion transformer model. Image generation model 1430 is an example of, or includes aspects of, the corresponding element described with reference to FIG. 6.

According to some aspects, image processing apparatus 1400 includes a training component. The training component is implemented as software stored in memory unit 1415 and executable by processor unit 1405, as firmware, as one or more hardware circuits, or as a combination thereof. According to some embodiments, the training component is implemented as software stored in a memory unit and executable by a processor in the processor unit of a separate computing device, as firmware in the separate computing device, as one or more hardware circuits of the separate computing device, or as a combination thereof. In some examples, the training component is part of another apparatus other than image processing apparatus 1400 and communicates with the image processing apparatus 1400. In some examples, training component is part of image processing apparatus 1400.

### Computing Device

FIG. 15 shows an example of a computing device 1500 according to aspects of the present disclosure. The example shown includes computing device 1500, processor 1505, memory subsystem 1510, communication interface 1515, I/O interface 1520, user interface component 1525, and channel 1530.

In some embodiments, computing device 1500 is an example of, or includes aspects of, the image processing apparatus described with reference to FIGS. 1 and 14. In some embodiments, computing device 1500 includes processor 1505 that can execute instructions stored in memory subsystem 1510 to obtain an input prompt indicating a target visual text, generate an intermediate image based on the input prompt, compute a character recognition loss based on the target visual text and the intermediate image, and generate a synthetic image based on the character recognition loss.

According to some embodiments, processor 1505 includes one or more processors. In some cases, processor 1505 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1505 is configured to operate a memory array using a memory controller. In other cases, a memory controller is integrated into processor 1505. In some cases, processor 1505 is configured to execute computer-readable instructions stored in a memory to perform various functions. In some embodiments, processor 1505 includes special-purpose components for modem processing, baseband processing, digital signal processing, or transmission processing. Processor 1505 is an example of, or includes aspects of, the processor unit described with reference to FIG. 14.

According to some embodiments, memory subsystem 1510 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1510 is an example of, or includes aspects of, the memory unit described with reference to FIG. 14.

According to some embodiments, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1515.

According to some embodiments, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or hardware components controlled by the I/O controller. I/O interface 1520 is an example of, or includes aspects of, the I/O module described with reference to FIG. 14.

According to some embodiments, user interface component 1525 enables a user to interact with computing device 1500. In some cases, user interface component 1525 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over conventional technology (e.g., conventional image generation models). Example experiments demonstrate that the image processing apparatus based on the present disclosure outperforms conventional image generation models. Details on the example use cases based on embodiments of the present disclosure are described with reference to FIG. 5.

The description and drawings described herein represent example configurations and do not represent all the implementations within the scope of the aspects. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt indicating a target visual text;
generating, using an image generation model, an intermediate image based on the input prompt;
computing a character recognition loss based on the target visual text and the intermediate image; and
generating, using the image generation model, a synthetic image based on the character recognition loss, wherein the synthetic image depicts the target visual text.

2. The method of claim 1, wherein computing the character recognition loss comprises:
performing character recognition on the intermediate image to obtain a predicted visual text; and
comparing the predicted visual text to the target visual text.

3. The method of claim 1, wherein generating the synthetic image comprises:
obtaining a noise input; and
denoising the noise input based on the character recognition loss.

4. The method of claim 3, further comprising:
computing a character recognition gradient based on the character recognition loss, wherein the noise input is denoised based on the character recognition gradient.

5. The method of claim 3, further comprising:
identifying a diffusion timestep range, wherein the character recognition loss is applied within the diffusion timestep range.

6. The method of claim 3, further comprising:
computing classifier free guidance based on the character recognition loss.

7. The method of claim 1, further comprising:
obtaining a character recognition strength parameter indicating a target strength of the character recognition loss, wherein the character recognition loss is applied based on the character recognition strength parameter.

8. The method of claim 1, further comprising:
normalizing the character recognition loss to obtain a normalized character recognition loss, wherein the synthetic image is generated based on the normalized character recognition loss.

9. A non-transitory computer readable medium storing code for image processing, the code comprising instructions that, when executed by at least one processor, cause the at least one processor to perform operations comprising:
obtaining an input prompt indicating a target visual text;
generating, using an image generation model, an intermediate image based on the input prompt;
performing character recognition on the intermediate image to obtain a predicted visual text; and
generating, using the image generation model, a synthetic image based on the target visual text and the predicted visual text, wherein the synthetic image depicts the target visual text.

10. The non-transitory computer readable medium of claim 9, the code further comprising instructions that, when executed by at least one processor, cause the at least one processor to perform operations comprising:
computing a character recognition loss based on the character recognition, wherein the synthetic image is generated based on the character recognition loss.

11. The non-transitory computer readable medium of claim 10, wherein generating the synthetic image comprises:
obtaining a noise input; and
denoising the noise input based on the character recognition loss.

12. The non-transitory computer readable medium of claim 11, the code further comprising instructions that, when executed by at least one processor, cause the at least one processor to perform operations comprising:
computing a character recognition gradient based on the character recognition loss, wherein the noise input is denoised based on the character recognition gradient.

13. The non-transitory computer readable medium of claim 11, further comprising:
identifying a diffusion timestep range, wherein the character recognition loss is applied within the diffusion timestep range.

14. The non-transitory computer readable medium of claim 11, further comprising:
computing classifier free guidance based on the character recognition loss.

15. The non-transitory computer readable medium of claim 10, further comprising:
obtaining a character recognition strength parameter indicating a target strength of the character recognition loss, wherein the character recognition loss is applied based on the character recognition strength parameter.

16. The non-transitory computer readable medium of claim 10, further comprising:
normalizing the character recognition loss to obtain a normalized character recognition loss, wherein the synthetic image is generated based on the normalized character recognition loss.

17. A system comprising:
a memory component; and
a processing device coupled to the memory component, the processing device configured to perform operations comprising:
obtaining an input prompt indicating a target visual text;
generating, using an image generation model, an intermediate image based on the input prompt;
computing a character recognition loss based on the target visual text and the intermediate image; and
generating, using the image generation model, a synthetic image based on the character recognition loss, wherein the synthetic image depicts the target visual text.

18. The system of claim 17, further comprising:
an optical character recognition (OCR) model configured to perform character recognition.

19. The system of claim 17, further comprising:
a text encoder configured to encode the input prompt to obtain a text embedding, wherein the synthetic image is generated based on the text embedding.

20. The system of claim 17, wherein:
the image generation model comprises a diffusion model.
